(19) United States
(12) Patent Application Publication
(10) Pub. No.: US 2008/0145062 A1
(43) Pub. Date: Jun. 19, 2008

(54) Apparatus for optical data transmission

(76) Inventors: Oliver Heuermann, Erlangen (DE); Peter Tichy, Uttenreuth (DE)

Correspondence Address: BRINKS HOFER GILSON & LIONE, P.O. BOX 10395, CHICAGO, IL, 60610, US

(21) Appl. No.: 11/999,619

(22) Filed: Dec. 6, 2007

(30) Foreign Application Priority Data
Dec. 15, 2006 (DE) DE 102006059442.8

(51) Int. Cl. H04B 10/00

(52) U.S. Cl. 398/140

(57) ABSTRACT

An apparatus for optical data transmission between components of a rotary system is provided. The apparatus include a number of transmit units and a number of receive units. The transmit units and the receive units are disposed such that at least one receive unit always lies in the region of the main radiation direction of at least one transmit unit.

The present patent document claims the benefit of the filing date of DE 10 2006 059 442.8 filed Dec. 15, 2006, which is hereby incorporated by reference.

### BACKGROUND

The present embodiments relate to optical data transmission between components of a rotary system.

In current medical diagnosis systems, such as computer tomography systems, large quantities of data accumulate in short time periods. The quantities of data are further processed to output a result. The image resolutions are also to be further improved in the future, which causes the quantities of data that accumulate for further processing purposes to increase. For diagnosis devices, the processing speed of the data is important for prompt diagnosis. The immediate ability to observe an event is desirable with a diagnosis method, for which a result output is required in real-time.

The data transmission rate between the parts, which can be moved in respect of each another, must be correspondingly high to maintain rapid data processing.

A data transmission between the rotor and the stator of a CT gantry is established by loop contacts or capacitative contactless transmit/receive structures. Alternatively, optical transmission systems are used for data transmissions between the rotor and the stator. Optical transmission systems are typically used with singular transmitter/receiver systems having one transmit unit and one receive unit. WO 96/24202 discloses optical data transmission systems particularly for computer tomography. The optical data transmission systems include a receive unit having a longitudinal shape and being permanently connected to the transmit unit by a light beam emitted from a transmit unit. The light beam is converted into fluorescence light in the receive unit. DE 10302435 B3 discloses an optical data transmission system including a number of transmit units and a receive unit. DE 10302435 B3 discloses only one transmit unit in contact with the receive unit at any one point in time.

The upper limit of the transmission rates with the current systems is approximately 5 gigabits per second.

Accordingly, prompt data transmission is restricted because of the high image resolutions and image resolutions which will increase further in the future, particularly in the field of computer tomography.

### SUMMARY AND DESCRIPTION

The present embodiments may overcome one or more of the drawbacks or limitations inherent in the related art. For example, in one embodiment, an optical data transmission system allows real-time transmission of high volumes of data, such as image data in the field of computer tomography. In another example, a computer tomography system may be used for diagnostic real-time observation.

In one embodiment, an apparatus for optical data transmission between components of a rotary system includes a number of transmit units and at least one receive unit. The transmit units and/ or each receive unit are embodied and arranged such that a receive unit is disposed, such as is always disposed, in the region of the main radiation direction of each transmit unit.

Data transmission rates of over 50 gigabits per second may be achieved with the apparatus. The transmission rate may be increased by a factor of 10 compared with that of the transmission methods currently used. High-resolution images may be transmitted in real-time particularly when used with a computer tomography system.

The data may be transmitted in parallel. The data to be transmitted may be divided onto a number of different partial streams, which are each assigned to a transmit unit. The number of partial streams and the transmit units may be predetermined from the size of the overall data and the transmit capacity restriction for each partial stream.

Each signal received on the receive side is assigned a spatiotemporal signature by the sending process of a specific transmit unit in each instance. The spatiotemporal signature renders the signal uniquely identifiable. The use of spatial coordinates as additional parameters of the data transmission enables the use of a plurality of transmission channels. High transmission rates with low bit-error-rates may be achieved using the spatial coordinates. Only one spatial transmission channel exists in the case of a system having only a transmit unit and a receive unit.

In one embodiment, the data to be transmitted is divided by a divider and is simultaneously sent via a number of transmit units grouped in an array. The transmit units may convert the data into light signals. The simultaneously sent signals of the data stream are continuously transmitted. A continuous transmission may be established by disposing at least one receive unit in the region of the main radiation direction of each transmit unit. This condition may apply to all geometric configurations of the rotary system, which may be adopted during the operation. The light signals emitted by the transmit units may be simultaneously detected by the receive unit(s).

The continuous data transmission may prevent transmission downtimes. Transmission downtimes may include buffering the data prior to transmission, thereby impeding an increase in the transmission speed.

In one embodiment, one or a number of receive unit(s) are embodied in a continuous path, or a number of receive units are combined in an array, such as an essentially continuous path.

For example, a receive path may include a foil circuit board. The grouping of receive units in an array, such as in a continuous path, may detect the signals of one or more transmit units during a continuous change in the position of the rotary system. The receive array or the receive path may be embodied such that a beam outgoing from one or each of the transmit units hits the receive array or the receive path during a continuous change in position of the system and tracks the course thereof.

In one embodiment, the transmit units include laser transmitters. Coherent laser light may be used for the transmission of data. The receive units then include photo detectors that record the emitted laser light. The photo detectors may include a semiconductor material.

A system may include a stator and a rotor. The system may be a computer tomography system, for example. Data transmission may take place between the rotor and stator.

In one embodiment, the transmit units are essentially arranged equally distributed across the periphery of the stator and/or the rotor. At least one receive unit surrounds the periphery of the stator or rotor, and/or a number of receive units are arranged equally distributed across the periphery of the stator and/or rotor.

The main flow of the data transmission may take place in one direction. In a computer tomography system, the diagnosis data is obtained in the rotor. The diagnosis data is transmitted from the rotor to the stator. The information stream, which is transmitted from the stator to the rotor, is noticeably smaller and may include control data for the rotor. The size and direction of the data streams to be transmitted determines the quantity and arrangement of the transmit units and the corresponding receive units on the rotor and stator in each instance. As the rotor rotates about any angle relative to the stator, the transmit units and the corresponding receive units are essentially arranged equally distributed on the rotor and/or stator respectively, in order to ensure a continuous data transmission.

In one embodiment, the rotor may include a hollow cylindrical base body. The stator may define an axis of a rotation for the rotor. This embodiment may be used with a computer tomography system.

In one embodiment, the base body of the rotor is introduced into the stator. An outer surface of the base body faces an inner surface of the stator. The data transmission may takes place between the opposing outer/inner surfaces of the rotor/stator, respectively. For example, data transmission may take place between the outer surface of the base body and the inner surface of the stator.

In one embodiment, at least one partial number of transmit units is arranged along at least one circular line on the outer surface of the base body or on the inner surface of the stator, and at least one partial number of the receive units is arranged on a circular path, which corresponds in each instance to the or each circular line, on the correspondingly opposing surfaces of the stator or the base body.

With the rotor/stator geometry, a circular line, which lies in a plane which runs orthogonally to the axis of rotation of the rotor, is rotationally symmetrical to both an external observer and the stator. The corresponding transmit/receive units may be arranged along the circular lines.

In one embodiment, a computer tomography system may include the previously described apparatus for optical data transmission.

### BRIEF DESCRIPTION OF THE FIGURE

FIG. 1 illustrates one embodiment of a stator with an insertable rotor.

### DETAILED DESCRIPTION

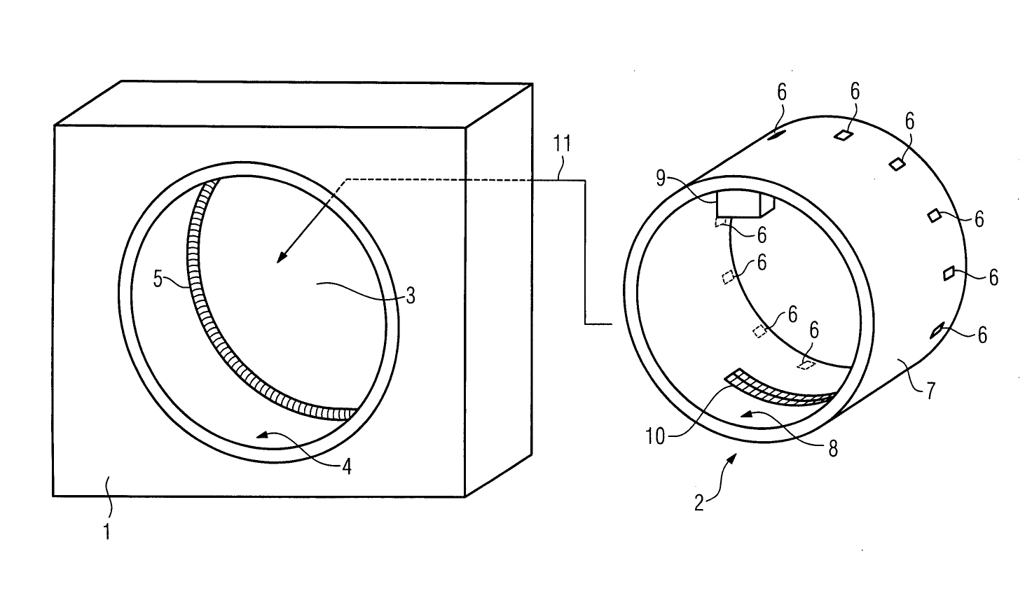

FIG. 1 shows a stator 1 with an insertable rotor 2. In one embodiment, a system, such as a computer tomography system, may include the stator 1 and the rotor 2.

The stator 1 may include a cylindrical center hole 3 with an inner surface 4. A receiver track 5 may include photosensitive semiconductors with given bandwidths on a foil circuit board. The photosensitive semiconductors may convert light pulses into electrical pulses. Optical fibers may be used. The receiver track 5 may be located on the inner surface 4. The receiver track 5 is formed along a circular line, which is shown as an intersecting line of the inner surface 4 having an imaginary plane which runs orthogonally to the longitudinal axis of the center hole 3. The receiver track 5 receives light pulses from a number of laser transmitters 6, which are arranged on the outer surface 7 of the rotor 2.

The rotor 2 may be inserted into the stator 1 as per arrow 11, so that the rotor 2 is mounted in the stator 1 in a rotatable fashion about the longitudinal axis. In the assembled state, the laser transmitters 6 lie opposite to the receiver track 5 in the imaginary orthogonal plane, so that the light beams emitted by the laser transmitters 6 can be captured by the receiver track 5 for each angle of rotation of the rotor 2 with respect to a fixed stator coordinate system. The inner surface 8 of the rotor 2 includes an x-ray emitter 9 and an x-ray detector 10 arranged opposite to the x-ray emitter 9. The x-ray detector 10 converts a recorded spatial attenuation into a data stream through a radiated volume. This data stream is split into parallel data streams, which are simultaneously routed to the individual laser emitters 6 and are converted there into light pulses. The light pulses are simultaneously emitted and received in the receiver track 5 by the photo detectors 10. The light pulses captured in the photo detectors 10 are then initially added again to the individual data streams and then to the overall data stream. The overall data stream may be fed to an evaluation unit in the stator 1.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. An apparatus for optical data transmission between components of a rotary system, the apparatus comprising:
a plurality of transmit units; and
at least one receive unit,
wherein the at least one receive unit is disposed in a region of a main radiation direction of each of the plurality of transmit units.

2. The apparatus as claimed in claim 1, wherein one or more receive units are disposed in a continuous path.

3. The apparatus as claimed in claim 1, wherein the transmit units include laser transmitters.

4. The apparatus as claimed in claim 1, wherein the receive units include photo detectors.

5. The apparatus as claimed in claim 1, wherein the receive units include optical fibers.

6. The apparatus as claimed in claim 1, wherein the rotary system includes a stator and a rotor.

7. The apparatus as claimed in claim 6, wherein the transmit units are disposed across the periphery of the stator, the rotor, or the combination thereof.

8. The apparatus as claimed in claim 6, wherein at least one receive unit surrounds the periphery of the stator or a number of receive units are arranged equally distributed across the periphery of the stator and/or the rotor.

9. The apparatus as claimed in claim 6, wherein the rotor includes a hollow-cylindrical base body and the stator defines an axis of rotation for the rotor.

10. The apparatus as claimed in claim 9, wherein the base body of the rotor is disposed in the stator.

11. The apparatus as claimed in claim 10, wherein at least one transmit unit is arranged along at least one circular line on the outer surface of the base body, and each receive unit is arranged on a circular path corresponding to each circular line, the circular line being on a corresponding opposing surface of the stator or base body.

12. A computer tomography system comprising:
at least one receive unit operable to receive data; and
a plurality of transmit units operable to transmit data,
wherein the at least one receive unit is disposed in a region of a transmit direction of each transmit unit.

13. The computer tomography system as claimed in claim 12, wherein the at least one receive unit is disposed on a rotor and the transmit units are disposed on a stator.

14. The computer tomography system as claimed in claim 13, wherein the rotor is disposed in the stator, so that the at least one receive unit is disposed in a region of a transmit direction of each transmit unit.

15. The apparatus as claimed in claim 1, wherein one or more receive units are combined in an array.

16. The apparatus as claimed in claim 15, wherein one or more receive units are disposed along an essentially continuous path.

17. The apparatus as claimed in claim 4, wherein the photo detectors include a semiconductor material.

18. The apparatus as claimed in claim 6, wherein at least one receive unit surrounds the periphery of the stator and a number of receive units are arranged equally distributed across the periphery of the stator and/or the rotor.

19. The apparatus as claimed in claim 10, wherein an outer surface of the base body and an inner surface of the stator lie opposite one another.

20. The apparatus as claimed in claim 10, wherein at least one transmit unit is arranged along at least one circular line on the inner surface of the stator, and each receive unit is arranged on a circular path corresponding to each circular line, the circular line being on a corresponding opposing surface of the stator or base body.
